(19) United States
(12) Patent Application Publication
(10) Pub. No.: US 2013/0262334 A1
(43) Pub. Date: Oct. 3, 2013

(54) SYSTEMS AND METHODS FOR PROVIDING SECONDARY DELIVERY SERVICE

(71) Applicant: Daniel Rozenblatt, Manhattan Beach, CA (US)

(72) Inventor: Daniel Rozenblatt, Manhattan Beach, CA (US)

(21) Appl. No.: 13/472,758

(22) Filed: May 16, 2012

Related U.S. Application Data
(60) Provisional application No. 61/619,426, filed on Apr. 3, 2012.

(51) Int. Cl. G06Q 10/08

(52) U.S. Cl. 705/330

(57) ABSTRACT

Methods and systems disclosed herein are used to manage delivery of a package to an intermediate delivery location by an initial carrier for subsequent delivery to a user by a secondary carrier. The user may register with a secondary delivery service provider by providing a user delivery address prior to having the package shipped to the intermediate delivery location. The secondary delivery service provider may provide the user with a physical address the intermediate delivery location. The user may then provide the address of the intermediate delivery location to any sender as part of a shipping address. Once the package is received at the intermediate delivery location, staff at the intermediate delivery location may release the package to the secondary carrier and the secondary carrier may deliver the package to the user delivery address.

### RELATED APPLICATIONS

This application claims priority to U.S. Provisional Patent Application Ser. No. 61/619,426, filed on Apr. 3, 2012, the disclosure of which is incorporated herein by reference in its entirety.

### FIELD

The present disclosure relates to managing delivery of a package to a user. More particularly, the present disclosure relates to managing delivery of a package to an intermediate delivery location (IDL) by an initial carrier for subsequent delivery to a user by a secondary carrier.

### BACKGROUND

Conventional shipping arrangements typically involve a sender, a carrier, and a recipient. The sender typically prepares a package to be shipped and arranges for the carrier to take possession of the package. After the carrier takes possession of the package, the carrier arranges for delivery of the package to the recipient. In the context of a package being shipped as part of a mail-order or Internet purchase, the sender is typically the merchant (e.g. Amazon.com) and the recipient is typically the customer of the merchant.

In a typical shipping arrangement, the sender chooses the carrier (e.g. FedEx, UPS, USPS, etc.). The carrier typically has regular delivery routes and regular delivery practices. For example, delivery practices may include providing package tracking details to the recipient or leaving packages unattended at the recipient's address when the recipient is not present at the time of delivery. The delivery routes and shipping practices often differ among various carriers.

In a typical delivery process, the carrier transports the package along its regular delivery route, stops at the recipient's address, and attempts to deliver the package. In many instances, however, the recipient may not be present to accept the package at the time of delivery. In such instances, the carrier generally follows its regular shipping practices. For example, the carrier may leave the package unattended at the recipient's address or attempt to deliver the package at a later time. The carrier may also return the package to a distribution center and hold the package for pick-up by the recipient or return the package to the sender.

Such shipping practices often differ among various carriers and can be frustrating for the recipient. For example, the recipient may live in a high-crime area and prefer that packages are not left unattended when no one is present to receive the package at the time of delivery. However, the carrier delivering the package may maintain the shipping practice of leaving packages unattended when the recipient is not present at the time of delivery.

In another typical delivery process, the carrier may provide package tracking details to the recipient before the delivery of the package. The recipient may then know in advance to expect the delivery of a package and may try to make arrangements to be present at the time of delivery.

Such arrangements, however, may be inconvenient for the recipient if the carrier maintains a delivery route that does not suit the recipient's schedule. For example, the carrier may follow a delivery route whereby packages are delivered to the recipient's address at a particular time of day when the recipient is usually at work. Or, the carrier may not provide the recipient with a small enough delivery window indicating the estimated time of delivery.

In other instances, the recipient may expect two or more packages to be delivered on the same day by two or more carriers. Because delivery routes often differ among various carriers, the recipient may need to make additional arrangements to be present at the time of each delivery.

The aforementioned difficulties faced by recipients occur when the carrier delivering the package maintains a delivery route and shipping practices that conflict with the schedule and preferences of the recipient. Thus, there remains a need to allow recipients to choose which carrier delivers packages to their address, independent of the carrier designated by the sender.

### BRIEF DESCRIPTION OF THE DRAWINGS

FIG. 1 is an overview of interactions and relationships and the flow of information and goods in a secondary delivery service system, according to an example embodiment.

FIG. 2 illustrates a system environment in which example embodiments and aspects may be implemented.

FIG. 3 is an illustration of a delivery management server (DMS), according to an example embodiment.

FIGS. 4-5 are flow diagrams showing aspects of a method, according to an example embodiment, for providing secondary delivery service to a user.

FIGS. 6-7 are flow diagrams showing aspects of a method for providing secondary delivery service to a user.

FIG. 8 is a flow diagram showing aspects of a method, according to an example embodiment, for determining whether a user delivery address is eligible for secondary delivery service.

FIG. 9 is a flow diagram showing aspects of a method, according to an example embodiment, for determining a projected delivery window.

FIG. 10 shows a computing environment in which example embodiments and aspects may be implemented.

FIG. 11 is a flow diagram showing aspects of a method, according to an example embodiment, for managing delivery of a package to an intermediate delivery location (IDL) by an initial carrier for subsequent delivery of the package to a user by a secondary carrier.

### DETAILED DESCRIPTION

Secondary delivery service, as used herein, refers to delivery of a package to a user (e.g., a recipient) by a secondary carrier differing from the initial carrier chosen, for example, by a sender. For example, the initial carrier may be designated by the sender or by any other entity involved in the shipping transaction. As used herein, the term “package” includes any item or parcel that can be delivered and the term “delivery window” refers to a period of time during which a package may be delivered. Moreover, the word “secondary” is used herein to mean not first in order of occurrence. Furthermore, for the purposes of this specification, the term “delivery management server” is synonymous with the term “secondary delivery service server”.

In the following detailed description, references are made to the accompanying drawings that form a part hereof, and in which are shown by way of illustration specific embodiments or examples.

Referring to the drawings, in which like numerals represent like elements throughout the several figures, example aspects of a computing system, and computer-implemented methodology for providing secondary delivery service will be presented.

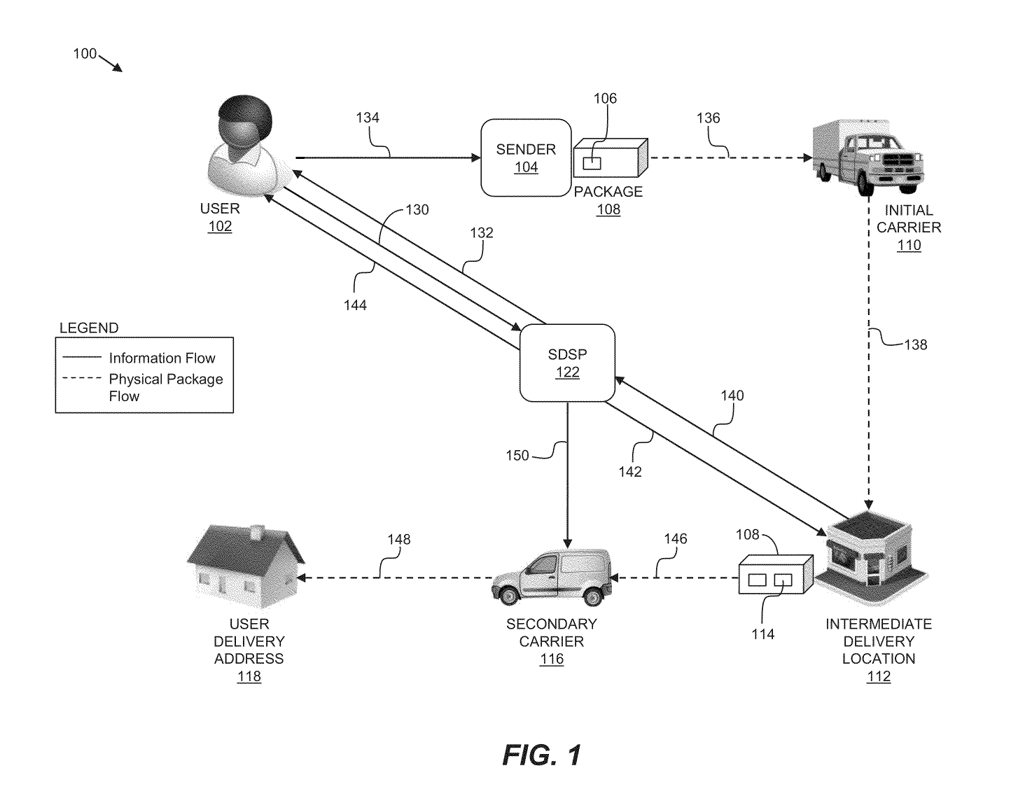

FIG. 1 illustrates example interactions and relationships of various entities that may be involved in an example secondary delivery service system 100, in accordance with an example embodiment. In this example, a user 102 (e.g., a subscriber to a delivery service) may register for secondary delivery service by communicating a user name and a user delivery address 118 to a secondary delivery service provider (SDSP) 122 via information flow 130. Once the SDSP 122 receives the user name and the user delivery address 118, the SDSP 122 may store the user name in association with the user delivery address 118 in a data store (not shown). The SDSP 122 may then communicate a physical address of an intermediate delivery location (IDL) 112 to the user 102 via information flow 132. The IDL 112 can include, for example, a retail store, a postal store, a distribution center, or any other staffed location able to receive packages. After the user 102 receives the physical address of the IDL 112 (the “IDL address”), the user 102 may provide the IDL address to a sender 104 (e.g., an electronic commerce retailer) via information flow 134. The sender 104 may generate a shipping label 106 bearing the IDL address and affix the label 106 to a package 108. The sender 104 may then transfer the package 108 to an initial carrier 110 via physical flow 136. The initial carrier 110 may deliver the package 108 to the IDL 112 via physical flow 138. Once the package 108 is received at the IDL 112, the IDL 112 may provide the user name (or any other user identifier) provided with the package to the SDSP 122 via information flow 140. Once the SDSP 122 receives the user name, the SDSP 122 may access the data store to identify the user delivery address 118 stored in association with the user name. The SDSP 122 may then provide the user delivery address 118 to the IDL 112 via information flow 142. The SDSP 122 may also notify the user 102 of the package receipt via information flow 144. The IDL 112 may then generate a shipping label 114 bearing the user delivery address 118 and affix the label 114 to the package 108. The IDL 112 may then transfer the package 108 to a secondary carrier 116 via physical flow 146. The secondary carrier 116 may then deliver the package 108 to the user delivery address 118 via physical flow 148.

According to another example embodiment, the SDSP 122 may provide the user delivery address 118 directly to the secondary carrier 116 via information flow 150 instead of (or in addition to) providing the user delivery address 118 to the IDL 112 via information flow 142. For example, this embodiment may pertain to a situation where the IDL 112 is either unable to generate the shipping label 114 or is otherwise unable to communicate the user delivery address 118 to the secondary carrier 116.

In another example embodiment, the user 102 may communicate the user name and the user delivery address 118 directly to the IDL 112 via an information flow (not shown). The IDL 112 may then store the user name in association with the user delivery address 118 in a data store (not shown), and may provide secondary delivery service to the user for any packages subsequently received at the IDL 112 bearing the user name. For example, after the package 108 bearing the user name is received at the IDL 112 via physical flow 138, the IDL 112 may access the data store to identify the user delivery address 118 stored in association with the user name, generate a shipping label 114 bearing the user delivery address 118, and affix the label 114 to the package 108. The IDL 112 may then transfer the package 108 to the secondary carrier 116 via physical flow 146. The secondary carrier 116 may then deliver the package 108 to the user delivery address 118 via physical flow 148. This alternative embodiment may pertain, for example, to a situation where the user 102 registers for secondary delivery service directly or in-person at the IDL 112.

The information flows depicted in FIG. 1 and described in the example embodiments above may encompass data transmissions (e.g., email, short message service, automated, instant messaging, etc.) and/or voice transmissions (e.g. phone call, in-person communication, etc.) over one or more networks. The networks may include packet data networks (e.g., the Internet, local area networks, wide area networks, etc.), cellular networks, the public switched telephone network, and any other type of network known in the art.

Additionally, alternative and supplementary information flows between entities depicted in FIG. 1 or included in the embodiments described above may be utilized in the secondary delivery service system 100, according to various example embodiments. Furthermore, one or more additional entities may be included in the secondary delivery service system 100, according to various example embodiments.

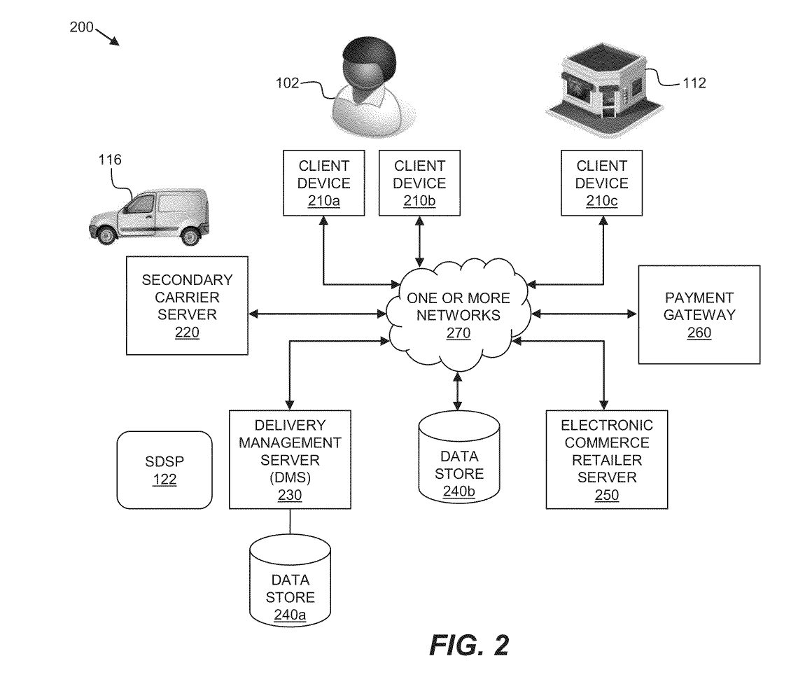

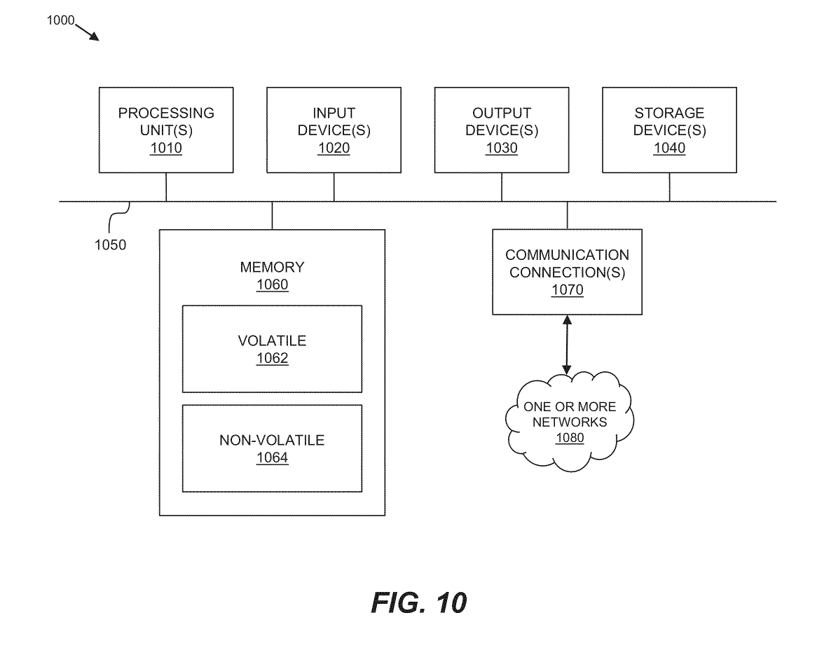

Merely by way of example, FIG. 2 illustrates a system environment 200 for providing secondary delivery service to a user, in accordance with an example embodiment. The system environment comprises a user (e.g., user 102) and an IDL (e.g., IDL 112) communicating with a secondary delivery service provider (e.g., SDSP 122) through a delivery management server (DMS) 230 using one or more client devices 210 over one or more networks 270. The one or more networks 270 may use standard communications technologies and/or protocols and may include any combination of wired or wireless networks including, but not limited to, packet data networks (e.g., the Internet, local area networks, wide area networks, etc.), cellular networks, the public switched telephone network, and any other type of network known in the art. The one or more client devices 210 may be configured to communicate with the DMS 230 in order to access, transmit, receive, and/or retrieve data from one or more data stores 240. The DMS 230 may be a server computer system configured to receive and transmit electronic data and may be implemented using one or more computer devices, such as computing system 1000 illustrated with respect to FIG. 10. Additionally, the system environment 200 may allow the DMS 230 to communicate over the one or more networks 270 with a secondary carrier server 220, an electronic commerce retailer server 250, a payment card gateway 260, and/or other computing devices (not shown).

The user and the IDL may communicate with DMS 230 using the one or more client devices 210 capable of communicating data over the one or more networks 270. For example, the one or more client devices 210 can be desktop computer, laptop computer, smart phone, mobile phone, personal digital assistant, tablet computer, and/or any other computing device that can receive user input and can receive and transmit data over a network, such as the computing system 1000 illustrated with respect to FIG. 10. The client devices may execute one or more applications that allow the user or the IDL to communicate with the DMS 230 electronically over a network including, but not limited to, web browsers, mobile applications, email applications, short message service applications, and/or any other applications configured to perform methods disclosed herein. For example, the user or the IDL may execute a web browser application (e.g., Internet Explorer, Mozilla Firefox, Safari, etc.) on a desktop computer to communicate with the DMS 230 by accessing a website hosted on the Internet by the DMS 230. Although the example system environment 200 illustrates the user using two client devices 210a, 210b and the IDL using one client device 210c, any number of client devices may be supported.

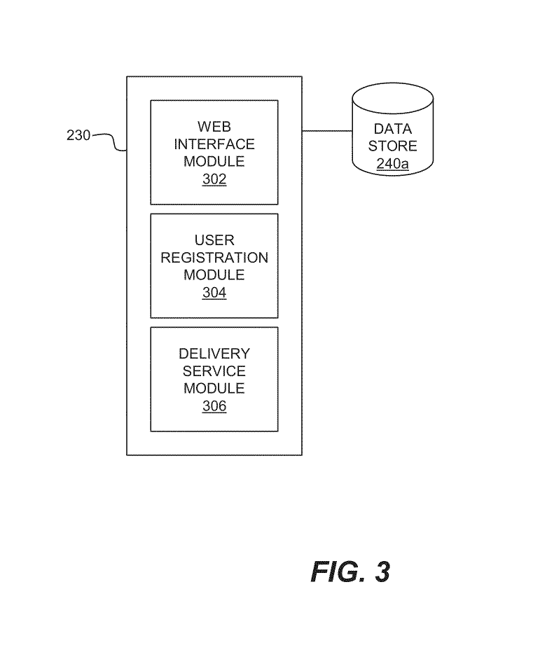

FIG. 3 is an illustration of the DMS 230, according to an example embodiment. By way of example, and not by limitation, the DMS 230 may include several components including, but not limited to, a web interface module 302, a user registration module 304, and a delivery service module 306. Additionally, the DMS 230 may access stored data on the one or more data stores 240. The location of the one or more data stores 240 is discretionary. For example, a data store 240a might reside on a storage medium local to the DMS 230. Alternatively, a data store 240b (shown in FIG. 2) may be remotely located from the DMS 230, so long as the DMS 230 can be in communication with the data store 240b. In other example embodiments, one or more of the DMS components may be combined, and additional, fewer, or different components may be included for various similar or alternative applications. Moreover, while the web interface module 302, the user registration module 304, and the delivery service module 306 are shown as each being part of the DMS 230, it is for illustrative purposes only; each may be implemented separately or together using one or more computing devices such as the computing system 1000 illustrated with respect to FIG. 10.

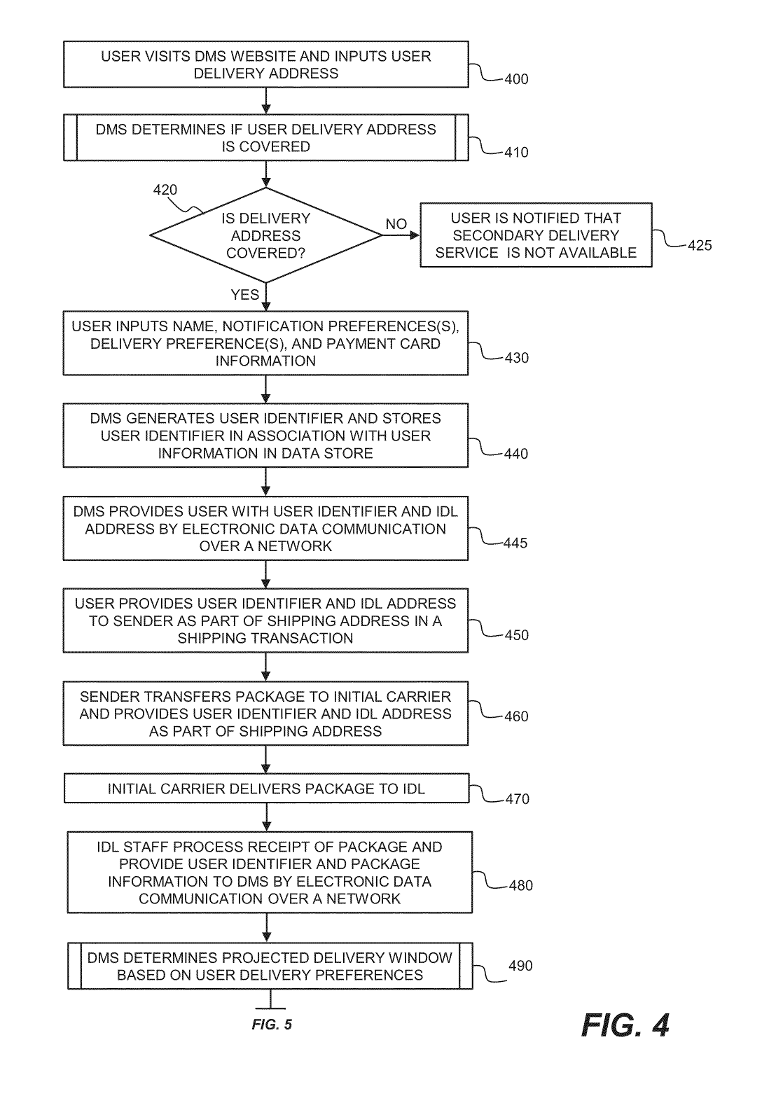

The web interface module 302, the user registration module 304, and the secondary delivery service module 306 may control certain aspects of the operation of the DMS 230. For example, as discussed in more detail below with regard to FIGS. 4-9, the web interface module 302 may be configured to receive and transmit data, between the DMS 230 and the one or more client devices 210, the secondary carrier server 220, the electronic commerce retailer server 250, and the payment gateway 260. For example, the web interface module 302 can receive, from the one or more client devices 210 and/or the electronic commerce retailer server 250, user information, such as a user name and a user delivery address, during a registration process. The web interface module 302 can then store the user information in the one or more data stores 240. During the registration process, the web interface module 302 can also provide data, such as a physical address of an IDL and a unique user identifier, to the one or more client devices 210 and/or the electronic commerce retailer server 250.

The web interface module 302 may also be configured to serve web pages, over the one or more networks 270. For example, the pages may include, but are not limited to, pages that allow users to register for secondary delivery service and update existing user information. The pages may also include pages that allow staff (e.g., an employee) at the IDL to input package information, view package history, view package status, etc. Additionally, the web interface module 302 may also facilitate communication between the user, the IDL, the secondary carrier, and the secondary delivery service provider, by receiving and transmitting emails, SMS (short message service) messages, instant messages, automated voice telephone calls, hosted website messages, and other forms of electronic messaging.

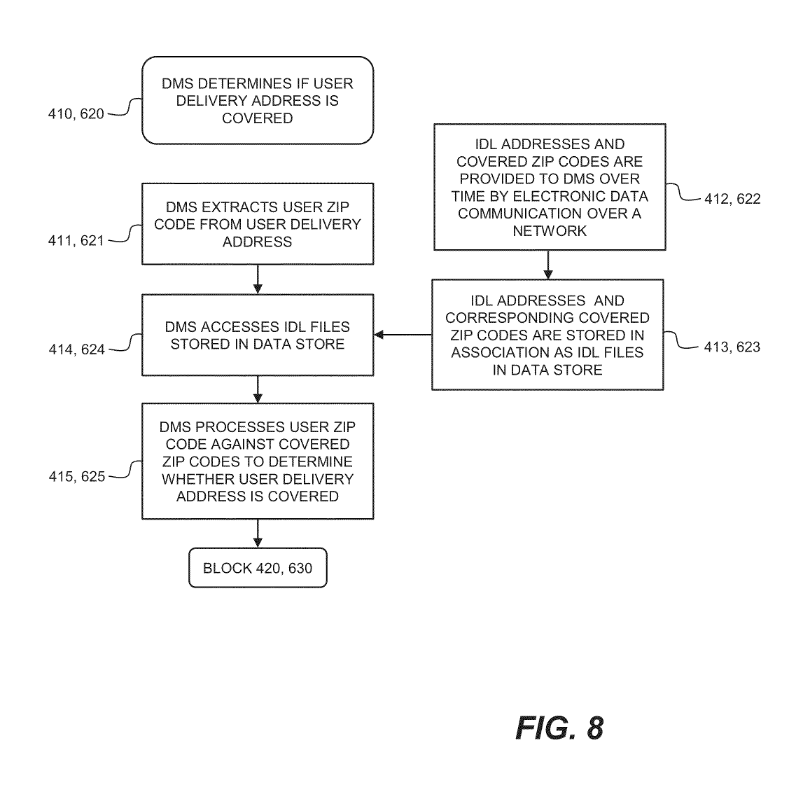

The user registration module 304 may be configured to determine whether a user delivery address is eligible for secondary delivery service (“covered”), as illustrated in more detail below with regard to FIG. 8. For example, the user registration module 304 may extract a user zip code from the user delivery address and process the user zip code against a data store of covered zip codes. If the user zip code is covered, the user registration module 304 may also be configured to identify an IDL address stored in association with the covered zip code.

The delivery service module 306 may be configured to process receipt of a package by accessing the one or more data stores 240 to identify user information, such as notification preferences, and payment information (e.g., a payment method), stored in association with a user identifier, as illustrated in more detail below with regard to FIGS. 4-9. For example, the delivery service module 306 can determine a preferred media for sending electronic notifications to a user based on the notification preferences stored in association with the user identifier. Additionally, the delivery service module 306 can also control electronically charging a user a fee based on the payment information stored in association with the user identifier.

The delivery service module 306 may also be configured to process release of a package by accessing the one or more data stores 240 to identify user information stored in association with a user identifier, as illustrated in more detail below with regard to FIGS. 4-9. For example, the delivery service module 306 may determine a projected delivery window for packages received at the IDL based on the delivery preferences stored in association with the user identifier.

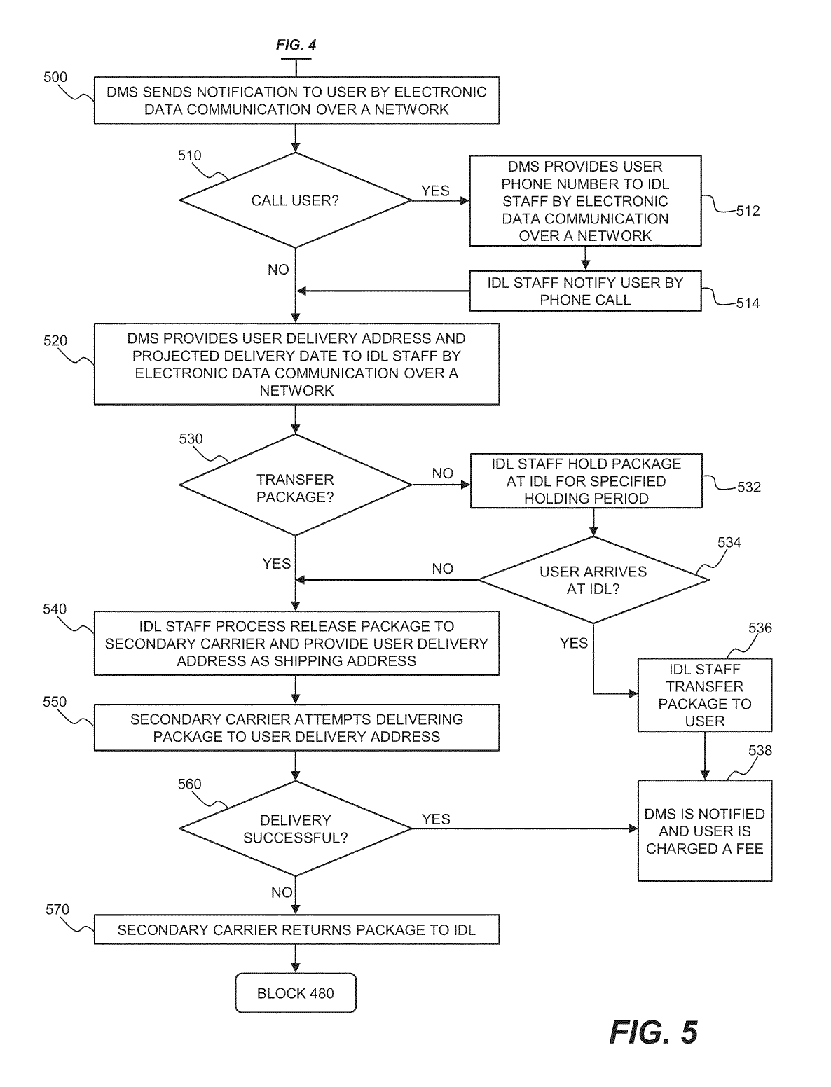

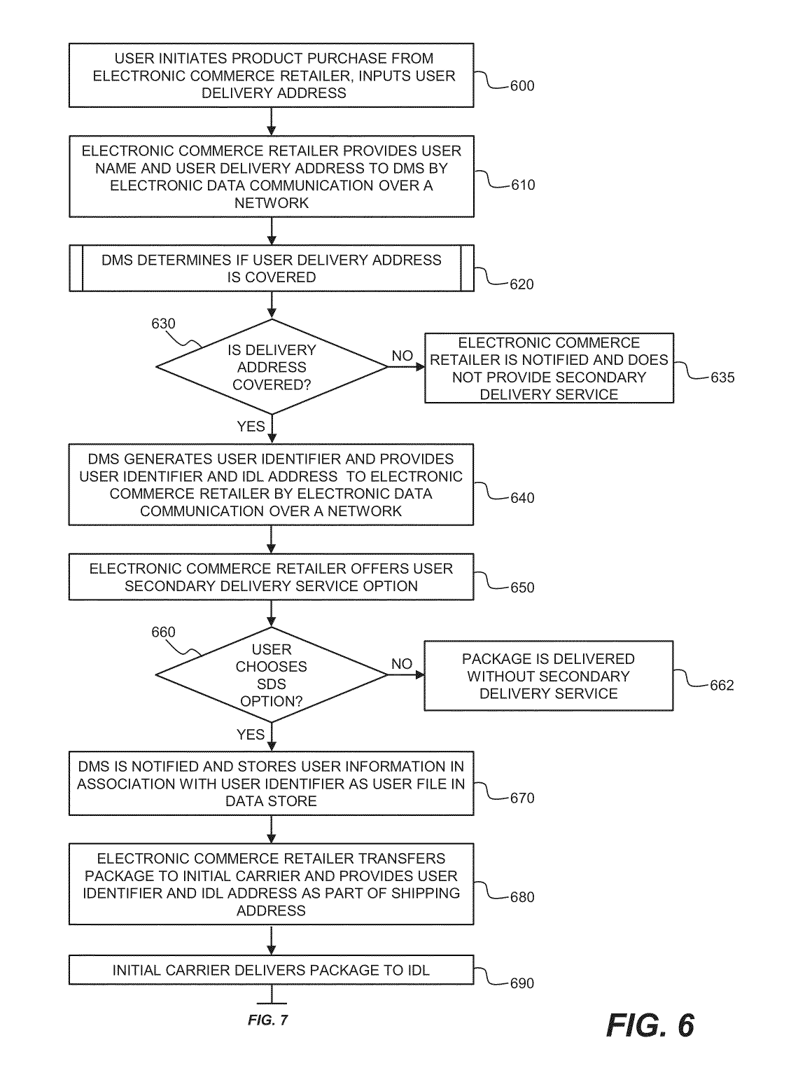

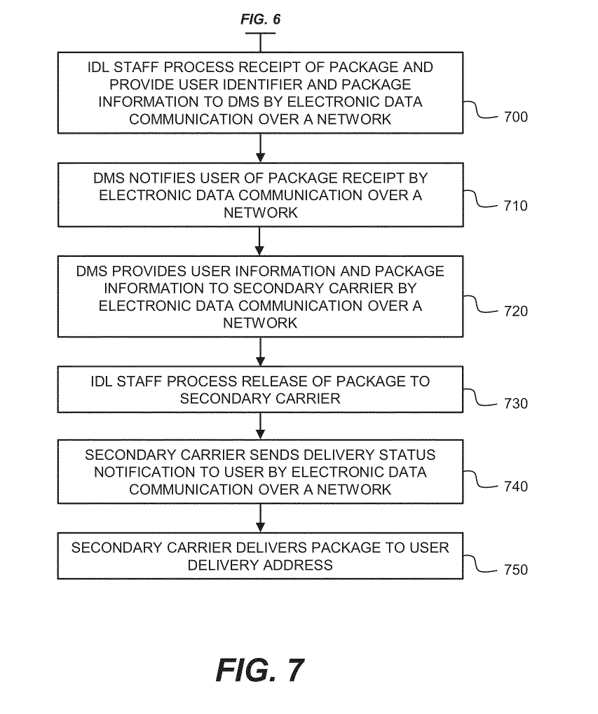

Referring back to FIG. 2, in another example aspect, the system environment may include a secondary carrier (e.g., secondary carrier 116) using a secondary carrier server 220 to communicate with the one or more client devices 210 and the DMS 230 over the one or more networks 270. The secondary carrier server 220 may be a server computer system configured to receive and transmit electronic data and may be implemented using one or more computing devices, such as the computing system 1000 illustrated with respect to FIG. 10. For example, in some example embodiments, the DMS 230 may provide the user delivery address directly to the secondary carrier server 220. In other example embodiments, the secondary carrier server 220 may provide package delivery information, such as package status and package delivery time, to the one or more client devices 210 and/or the DMS 230. For example, as discussed in more detail below with regard to FIG. 5-6, the secondary carrier can provide package delivery information to the DMS upon successful delivery of a package by the secondary carrier.

In yet another example aspect, the system environment may include an electronic commerce retailer server 250 that can be accessible to a user (e.g., user 102) via the one or more networks 270 and can host one or more applications. For example, the electronic commerce retailer server 250 may host an electronic commerce website on the Internet that can be accessed by the user using a browser application executed on a user client device 210. The electronic commerce retailer server 250 may be implemented using one or more computing devices such as the computing system 1000 illustrated by way of example with respect to FIG. 10. According to an example embodiment, the electronic commerce retailer server 250 can communicate with the DMS 230 over a network in order to register a user for secondary delivery service. For example, as discussed in more detail below with regard to FIGS. 6-7, the electronic commerce retailer server 250 may register a user for secondary delivery service by providing a user name (or any other user identifier) and a user delivery address to the DMS 230 to determine if the user delivery address is eligible for secondary delivery service (“covered”). If the user delivery address is covered, the DMS 230 may provide to the electronic commerce retailer server 250 the address of an IDL to which the electronic commerce retailer 250 may ship one or more products ordered by the user.

In still another example aspect, the system environment may include a payment gateway 260 that can facilitate payment card (e.g. credit card, debit card, etc.) transactions on behalf of the secondary delivery service provider, the IDL, and/or the secondary carrier. For example, using the one or more client devices 210, the user may provide payment information (e.g., a payment method) to the DMS 230 for payment transactions associated with packages delivered using the secondary delivery service. The DMS 230 may then store the payment information in the one or more data stores 240 and can send the payment information to the payment gateway 260 in order to charge the user a fee. Examples of payment gateways that may be used include, Authorize.Net, Chase Paymentech, CyberSource, and PayPal Payflow. It should be noted that any payment gateway or payment processing system can be used to handle payment transactions.

Reference is now made to FIGS. 4-5, which illustrate an example delivery process by which secondary delivery service may be provided to a user according to an example embodiment. As shown in Block 400, the process may be initiated when the user visits a website hosted by a DMS (the “DMS website”). The user may register for secondary delivery service by inputting a user delivery address to which the user would like to have a package delivered. The user delivery address can include, for example, a user zip code. For example, this may be performed using a browser application executed on a user client device connected to the Internet. However other means of communication are possible, as can be appreciated.

Next, in Block 410, the DMS may determine if the user delivery address is eligible for secondary delivery service (“covered”). The determination may be based on the proximity of the user delivery address to one or more IDLs. For example, a determination that the user delivery address is covered may include identifying an IDL address stored in association with the user delivery address or the user zip code in a data store. This example process in Block 410 will be described in greater detail below with regard to FIG. 8. Once the DMS determines whether the user delivery address is covered, decision Block 420 directs the DMS to the next step in the process. If, in Block 410, it is determined that the user delivery address is not covered, the DMS may notify the user, by electronic data communication over a network, that secondary delivery service is not available (Block 425). If, however, in Block 410 it is determined that the user delivery address is covered, the DMS may solicit the user to input additional user information (Block 430). For example, the user information can include a name of the user, notification preferences (e.g., preferred media for receiving electronic notifications such as email, SMS message, telephone, etc.), delivery preferences (e.g., preferred days and preferred times to receive deliveries) and payment information (e.g., a payment method such as a credit card or debit card, a billing address, a payment plan, etc.).

Once the user information is received by the DMS, the DMS may generate a unique user identifier identifying the user and store the user identifier in association with the user information obtained in Block 430 as a user file in a data store (Block 440). The user identifier can be, for example, an alpha code, a numeric code, an alphanumeric code, a bar code, a two-dimensional bar code, a radio frequency identification tag, and combinations thereof. In other example embodiments, the user identifier can simply be a name of the user with little or no alteration (e.g., Michael Smith). In Block 445, the DMS may provide to the user, by electronic data communication over a network, the user identifier and a physical address of the IDL (the “IDL address”) identified in Block 410.

Sometime after registering, the user may provide the user identifier and the IDL address to a sender as part of a shipping address in a shipping transaction (Block 450). A shipping transaction, for example, can include the purchase of a product from an electronic commerce retailer, or any other shipping transaction in which a user (e.g., a recipient) provides a shipping address to a sender. In Block 460, the sender may transfer possession of a package to an initial carrier and may provide the user identifier and the IDL address to the initial carrier as part of a shipping address. Then, in Block 470, the initial carrier may deliver the package to the IDL. The initial carrier can be any delivery service provider (e.g., FedEx, UPS, USPS, etc.) the sender engages to deliver the package.

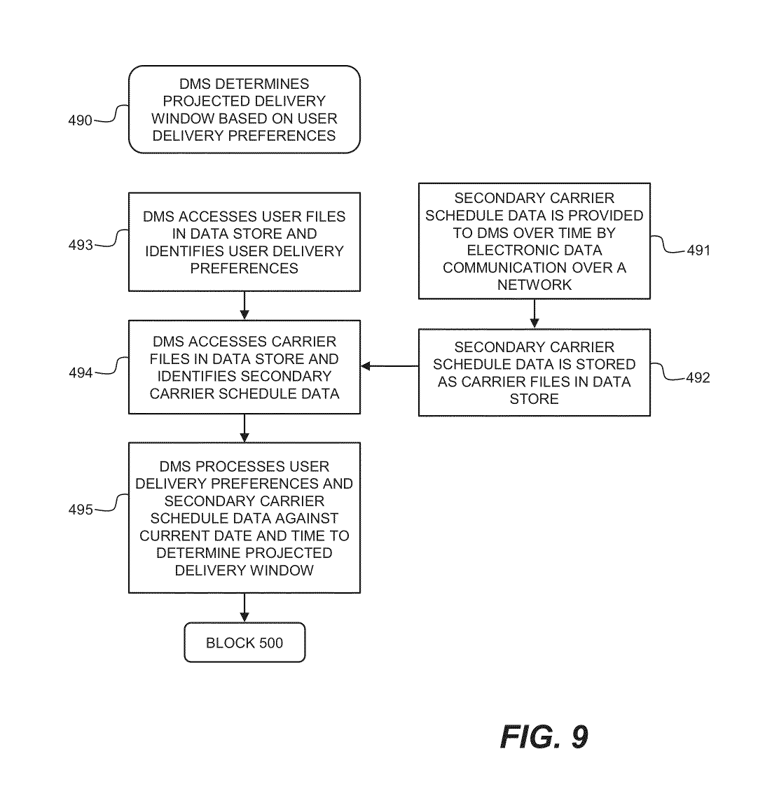

In Block 480, staff at the IDL (the “IDL staff”) may process receipt of the package by providing the user identifier provided with the package to the DMS, by electronic data communication over a network. The IDL staff may also provide to the DMS package information such as a sender name, a tracking number, a date of receipt, etc. For example, the IDL staff may access the DMS website using a computer connected to the Internet at the IDL (the “IDL computer”). The DMS may then prompt the IDL staff, through a browser application executed on the IDL computer, to input the user identifier and the package information. The DMS may then store the package information in association with the user identifier as a shipment file in a data store. Next, in Block 490, the DMS may determine a projected delivery window based on the delivery preferences received in Block 430. This process in Block 490 will be described in greater detail below with regard to FIG. 9.

Continuing to FIG. 5, after determining a projected delivery window, the DMS, in Block 500, may send the user a notification based on the notification preferences received in Block 430. For example, if the user inputted a preference to receive SMS messages, the DMS may send an SMS notification to the user. The notification can include, for example, the package information received in Block 480 and the projected delivery window determined in Block 490. In decision Block 510, the DMS may determine if the notification preferences include the telephone as a preferred media for receiving notifications. If the user prefers to be called, the DMS may provide to the IDL staff, by electronic data communication over a network, a user phone number (Block 425). For example, the user phone number may be displayed on a web page served to a browser application executed on the IDL computer. In Block 514, the IDL staff may call the user via a phone network (e.g., a cellular network, the public switched telephone network, a VoIP network, etc.) to notify the user that the package was received. In other example embodiments, the user may be called by using an automated voice response system.

Next, in Block 520, the DMS may access the user file in the data store to identify the user delivery address associated with the user identifier. The DMS may then provide the user delivery address and the projected delivery window to the IDL staff, by electronic data communication over a network. For example, the user delivery address and the projected delivery window may be displayed on a web page served to a browser application executed on the IDL computer.

In decision Block 530, the IDL staff may determine whether to release the package to a secondary carrier (Block 540) or to hold the package for a specified holding period (Block 532). For example, if the projected delivery window is determined to fall on the same date the package is received at the IDL, the IDL staff may transfer possession of the package to the secondary carrier the same date the package is received. If, however, the projected delivery window is determined to fall on a later date, the IDL staff may hold the package for a specified holding period. The holding period in Block 532 may also be based on one or more additional factors including, but not limited to, the ability of the secondary carrier to provide delivery service, national holidays, and the like. During the holding period, the user may retrieve the package in-person at the IDL (Block 534). If the user arrives at the IDL during the holding period, the IDL staff may transfer possession of the package to the user in Block 536. Then, in Block 538, the IDL staff may notify the DMS, by electronic data communication over a network, that possession of the package was transferred to the user. For example, the IDL staff may access the DMS website through the IDL computer to indicate that the package was successfully transferred to the user. The DMS may then charge the user a fee for using the service. For example, the DMS may access the user file stored in the data store to identify the payment information associated with the user identifier and provide, by electronic data communication over a network, the payment information to a payment gateway.

If, however, the user does not retrieve the package during the holding period, the IDL staff may, in Block 540, process release of the package to a secondary carrier by providing the secondary carrier with the user delivery address received in Block 520. For example, the IDL staff may generate a shipping label bearing the user delivery address and affix the label to the package before transferring possession of the package to the secondary carrier. In other example embodiments, the user delivery address may be provided directly to the secondary carrier through email, the DMS website, or a secondary carrier server.

Next, in Block 550, the secondary carrier may attempt delivering the package to the user delivery address. If, in Block 560, the secondary carrier is successful in delivering the package to the user delivery address, the secondary carrier may notify the DMS, by electronic data communication over a network, that the package was successfully delivered. In Block 538, the DMS may electronically charge the user a fee for using the service. For example, the secondary carrier may carry a portable computing device that can transmit package delivery information, such as the date and time of delivery, to the DMS. Upon receiving a notification that the package was successfully delivered, the DMS may provide to a payment gateway, by electronic data communication over a network, the payment information stored in the user file in the data store.

If, however, in Block 560, the secondary carrier is unsuccessful in delivering the package to the user delivery address, the secondary carrier may return the package to the IDL (Block 570). For example, the secondary carrier may stop at the IDL at the end of a delivery route in order to return packages that were not delivered. The example delivery process may then return to Block 480 and a new projected delivery window may be determined. For example, if the package is returned to the IDL on Monday and the delivery preferences associated with the user identifier include not receiving packages on Tuesdays and Wednesdays, the new projected delivery window may be determined to fall on Thursday. The IDL staff may then process release of the package to the secondary carrier for Thursday. The process of determining a projected delivery window will be described in greater detail below with regard to FIG. 9. In other example embodiments, the secondary carrier may not return the package to the IDL in Block 570. Instead, the secondary carrier may retain possession of the package and attempt to deliver the package by methods outside the scope of this disclosure.

Reference is now made to FIGS. 6-7, which illustrate an example delivery process by which secondary delivery service may be provided to a user according to another example embodiment. As shown in Block 600, the process may be initiated when the user purchases goods from an electronic commerce retailer and provides to the electronic commerce retailer, by electronic data communication over a network, user information such as a user delivery address. For example, this may performed by accessing a website, hosted on the internet by an electronic commerce retailer server, using a browser application executed on a user client device connected to the Internet. However other means of communication between the user and the electronic commerce retailer are possible. Furthermore, in some example embodiments, the example delivery process described with regard to FIGS. 6-7 may instead be implemented with a mail-order retailer or any other business that sells goods in a manner requiring shipment of the goods to a user (e.g., a customer).

Next, in Block 610, the electronic commerce retailer may attempt to register the user for secondary delivery service by providing to a DMS, by electronic data communication over a network, the user information including, but not limited to, the user delivery address. For example, the electronic commerce retailer may also provide to the DMS a user name, a user email, a user phone number, user delivery preferences, user notification preferences, etc. Then, in Block 620, the DMS may determine if the user delivery address is eligible for secondary delivery service (“covered”). The determination may be based on the proximity of the user delivery address to one or more IDLs. For example, a determination that the user delivery address is covered may include identifying an IDL address stored in association with the user delivery address or the user zip code in a data store. This example process in Block 620 will be described in greater detail below with regard to FIG. 8. Once the DMS makes a determination whether secondary delivery service is available for the user, decision Block 630 directs the DMS to the next step in the process. If, in Block 620, it is determined that the user delivery address is not covered, the DMS may notify the electronic commerce retailer, by electronic data communication over a network, and the electronic commerce retailer does not provide secondary delivery service as a shipping option to the user (Block 635). If, however, in Block 620, it is determined that the user delivery address is covered, the DMS may, in Block 640, generate a unique user identifier identifying the user. The user identifier can be, for example, an alpha code, a numeric code, an alphanumeric code, a bar code, a two-dimensional bar code, a radio frequency identification tag, and combinations thereof. In other example embodiments, the user identifier can simply be a name of the user with little or no alteration (e.g. Michael Smith). In Block 640, the DMS may also provide to the electronic commerce retailer, by electronic data communication over a network, the user identifier and a physical address of the IDL (the “IDL address”) identified in Block 620.

In Block 650, the electronic commerce retailer may offer secondary delivery service as a shipping option to the user. If, in Block 660, the user does not choose the secondary delivery service option, the goods being purchased (e.g., the “package”) may be shipped by methods outside the scope of this disclosure. If, however, the user chooses the secondary delivery service option, the electronic commerce retailer may notify the DMS, by electronic data communication over network, and the DMS may store the user information received in Block 610 in association with the user identifier as a user file in a data store (Block 670).

In Block 680, the electronic commerce retailer may transfer possession of the package to an initial carrier and may provide the user identifier and the IDL address to the initial carrier as part of a shipping address. The initial carrier can be any delivery service provider (e.g., FedEx, UPS, USPS, etc.) that the sender engages to deliver a package. In Block 690, the initial carrier may deliver the package to the IDL.

Continuing to FIG. 7, in Block 700, staff at the IDL (the “IDL staff”) may process receipt of the package by providing the user identifier provided with the package to the DMS, by electronic data communication over a network. The IDL staff may also provide to the DMS package information such as a sender name, a tracking number, a date of receipt, etc. For example, the IDL staff may access the DMS website using a computer connected to the Internet at the IDL (the “IDL computer”). The DMS may then prompt the IDL staff, through a browser application executed on the IDL computer, to input the user identifier and the package information. The DMS may then store the package information in association with the user identifier as a shipment file in a data store.

Next, in Block 710, the DMS may send the user a notification based on the notification preferences, if any, received in Block 610. For example, if the electronic commerce retailer provided a user email address to the DMS, the DMS may send an email notification to the user email address. The notification can include, for example, the package information received in Block 700.

In Block 720, the DMS may retrieve the user information from the user file, and the package information from the shipment file, and provide both information to a secondary carrier, by electronic data communication over a network. For example, the DMS may provide the user information and the package information to the secondary carrier through email, the DMS website, or a secondary carrier server.

Next, in Block 730, the IDL staff may process release of the package to the secondary carrier. For example, the IDL may notify the DMS, by electronic data communication over a network, that the possession of the package was transferred to the secondary carrier. In Block 740, the secondary carrier may send a delivery notification to the user, by electronic data communication over a network. For example, the notification can include the package information, a package status, a projected delivery window, etc. The package status and the projected delivery window may be determined by the secondary carrier by methods outside the scope of this disclosure. In other example embodiments, the package status and the projected delivery window may be determined by the DMS. In Block 750, the secondary carrier may deliver the package to the user delivery address and the example delivery process ends.

Reference is now made to FIG. 8, which provides further detail of the example processes introduced in Block 410 in FIG. 4 and Block 620 in FIG. 6, in which the DMS may determine if a user delivery address is covered, a determination that may be based on the user delivery address, among other factors. The example process may begin in Blocks 411 and 621 when the DMS extracts a user zip code from the user delivery address. The user zip code can be an alphanumeric postal code appended to the user delivery address for the purpose of sorting mail (e.g., 22313, 22313-1450, C1125).

Once the DMS has extracted a user zip code, the DMS may be ready to process the user zip code against a data store of zip codes that are eligible for secondary delivery service (“covered zip codes”). As shown in Blocks 412 and 622, IDL addresses and covered zip codes may be provided to the DMS over time, by electronic data communication over a network. For example, the covered zip codes may be determined based on availability of IDLs, the proximity of IDLs to the covered zip codes, and the geographic service area of a secondary carrier, among other factors. In Blocks 413 and 623, the IDL addresses are stored in association with the covered zip codes as IDL files in a data store accessible to the DMS. For example, each IDL file may correspond to a specific IDL and may include the physical address of the IDL and the covered zip codes associated with the IDL.

In Blocks 414 and 624, the DMS may access the IDL files stored in the data store, and, in Blocks 415 and 625, the DMS may process the user zip code against the covered zip codes stored in the IDL files. If the user zip code matches a covered zip code, the DMS may determine that the user delivery address is covered (e.g., eligible for secondary delivery service), and may then identify the IDL address stored in association with the covered zip code. On the contrary, if the user zip code does not match any of the covered zip codes, the DMS may determine that the user delivery address is not covered, and therefore not eligible for secondary delivery service.

Once the DMS has determined whether the user delivery address is covered, the example delivery service processes return to decision Block 420 (for the process introduced in FIG. 4) and to decision Block 630 (for the process introduced in FIG. 6).

Reference is now made to FIG. 9, which provides further detail of the example process introduced in Block 490 in FIG. 4, in which the DMS may determine a projected delivery window, a determination that may be based on delivery preferences and/or secondary carrier schedule data, among other factors. The example process may begin in Block 491 when secondary carrier schedule data may be provided to the DMS over time, by electronic data communication over a network. Secondary carrier schedule data can include, for example, days and times of operation and non-operation. For example, a secondary carrier may only operate Monday through Friday between 9:00 AM to 5:00 PM. In Block 492, the secondary carrier schedule data may be stored as carrier files in a data store accessible to the DMS.

In Block 493, the DMS may access user files stored in a data store to identify delivery preferences stored in association with a user identifier. The delivery preferences can include, for example, preferred days and preferred times to receive deliveries. In Block 494, the DMS may access the carrier files to identify the secondary carrier schedule data provided in Block 491. Then, in Block 495, the DMS may process the delivery preferences and the secondary carrier schedule data against the current date and time to determine a projected delivery window. For example, the user may prefer to not receive packages on Fridays and the secondary carrier may not operate on Saturdays and Sundays. A package received at an IDL on Friday may then be released to the secondary carrier to deliver to the user delivery address on Monday. Once the DMS has determined the projected delivery window, the example delivery process returns to Block 500 in FIG. 5.

Reference is now made to FIG. 10, which illustrates an example computing environment in which example embodiments and aspects may be implemented. The computing system environment is only one example of a suitable computing environment and is not intended to suggest any limitation as to the scope of use or functionality.

Furthermore, numerous other general purpose or special purpose computing system environments or configurations may be used. Examples of well-known computing systems, environments, and/or configurations that may be suitable for use include, but are not limited to, personal computers, server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 10, an example system for implementing aspects described herein includes a computing device, such as computing system 1000. In its most basic configuration, computing system 1000 typically includes at least one processing unit 1010 and memory 1060. Depending on the exact configuration and type of computing device, memory 1060 may be volatile 1062 (such as random access memory (RAM)), non-volatile 1064 (such as read-only memory (ROM), flash memory, etc.), or some combination of the two.

Computing system 1000 may have additional features/functionality. For example, computing system 1000 may include additional storage device(s) 1040 (removable and/or non-removable). By way of example, storage device(s) 1040 may be disk drives, optical storage devices, a solid-state storage device such as a random access memory (“RAM”) and/or a read-only memory (“ROM”), which can be programmable, flash-updateable and/or the like.

Computing system 1000 typically includes a variety of computer readable media. Computer readable media can be any available media that can be accessed by computing system 1000 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 1060 and storage device(s) 1040 are both examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system 1000. Any such computer storage media may be part of computing system 1000.

Computing system 1000 may contain communications connection(s) 1070 that allow the device to communicate with other devices. Communication connection(s) 1070 may include, but is not limited to, a modem, a Network Interface Card (NIC), an integrated network interface, a radio frequency transmitter/receiver, an infrared port, a USB connection, or other interfaces for connecting computing device 1070 to other computing devices. Communication connection(s) 1070 may include a wired connection or a wireless connection. Communication connection(s) 1070 may transmit and/or receive communication media.

Computing system 1000 may operate in a networked environment using logical connections to remote computing devices through one or more networks 1080. The one or more networks 1080 may use standard communications technologies and/or protocols and may include any combination of wired or wireless networks including, but not limited to, packet data networks (e.g., the Internet, local area networks, wide area networks, etc.), cellular networks, the public switched telephone network, and any other type of network known in the art.

Computing system 1000 may also have input device(s) 1020 such as a keyboard, mouse, pen, voice input device, touch input device, etc. Output device(s) 1030 such as a display, speakers, printer, etc. may also be included. All these devices are well known in the art and need not be discussed at length here.

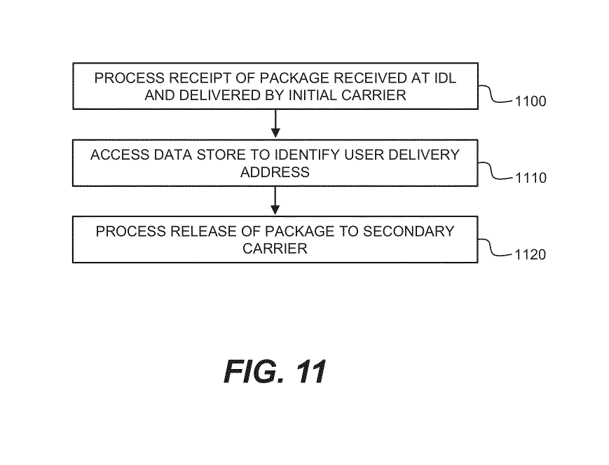

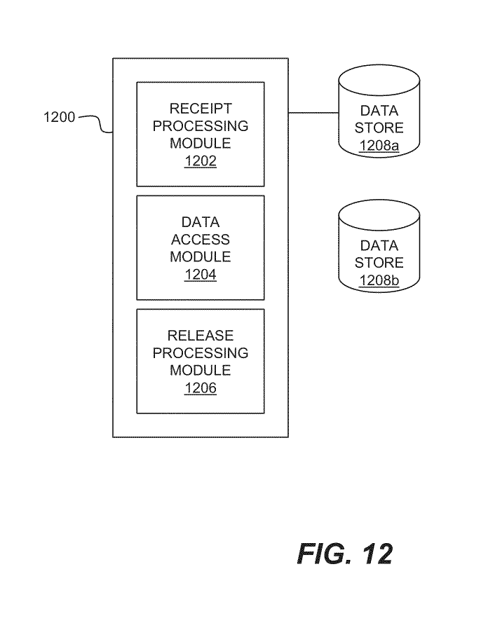

Reference is now made to FIG. 11, which illustrates an example embodiment for managing delivery of a package to an IDL by an initial carrier for subsequently delivery to a user by a secondary carrier.

In Block 1100, the package is delivered to the IDL by the initial carrier and receipt of the package is electronically processed. A user identifier associated with the user may be provided with the package and may be used to electronically process receipt of the package. For example, staff at the IDL (the “IDL staff”) may provide the user identifier to a DMS indicating the package was received. The DMS may then send an electronic notification to the user notifying the user that the package was received. In another example embodiment, the DMS may also electronically charge a payment method associated with the user identifier in response to receiving the user identifier from the IDL.

Next, in Block 1110, a data store may be accessed to identify a user delivery address associated with the user identifier. The user delivery address may be provided during a registration process prior to receiving the package at the IDL. For example, the user may provide the user delivery address to a DMS during a registration process prior to having the package shipped to the IDL. In another example embodiment, the user may also provide delivery preferences to the DMS, such as preferred days and preferred times for receiving packages.

After the user delivery address is identified in Block 1110, release of the package to the secondary carrier is electronically processed in Block 1120. For example, a DMS may provide the user delivery address to the IDL. The IDL staff may then generate a shipping label bearing the user delivery address and affix the label to the package. The IDL staff may then release the package with the affixed label to the secondary carrier. In another example embodiment, the DMS may identify user delivery preferences associated with the user identifier. The DMS may then determine a projected delivery window based on the delivery preferences and provide the projected delivery window to the IDL. Staff at the IDL may then release the package to the secondary carrier based on the projected delivery window.

Reference is now made to FIG. 12, which illustrates an example system 1200 in which example embodiments and aspects may be implemented. By way of example, and not by limitation, the system 1200 may include several components including, but not limited to, a receipt processing module 1202, a data access module 1204, and a release processing module 1206. Additionally, the system 1200 may access stored data on one or more data stores 1208. The location of the one or more data stores 1208 is discretionary. For example, a data store 1208a might reside on a storage medium local to the system 1200. Alternatively, a data store 1208b may be remotely located from the system 1200, so long as the system 1200 can be in communication with the data store 1208b. In other example embodiments, one or more of the system components may be combined, and additional, fewer, or different components may be included for various similar or alternative applications. Moreover, while the receipt processing module 1202, the data access module 1204, and the release processing module 1206 are shown as each being part of the system 1200, it is for illustrative purposes only; each may be implemented separately or together using one or more computing devices such as the computing system 1000 illustrated with respect to FIG. 10.

The receipt processing module 1202 may be configured to process receipt of a package delivered to an intermediate delivery location by an initial carrier. For example, the receipt processing module 1202 may be configured perform aspects of the method shown in Block 1100 illustrated with respect to FIG. 11.

The data access module 1204 may be configured to access the one or more data stores 1208 to identify a user delivery address associated with a user identifier. For example, the data access module 1204 may be configured perform aspects of the method shown in Block 1110 illustrated with respect to FIG. 11.

The release processing module 1206 may be configured to process release of the package to a secondary carrier, differing from the initial carrier, to deliver the package to the user delivery address. For example, the release processing module 1206 may be configured perform aspects of the method shown in Block 1120 illustrated with respect to FIG. 11.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (e.g., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although example embodiments may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

In addition, the articles “a” and “an” as used in this application and the appended claims may generally be construed to mean “one or more” unless specified otherwise or clear from context to be directed to a singular form. Moreover, to the extent that the terms “includes”, “having”, “has”, “with”, or variants thereof are used in either the detailed description or the claims, such terms are intended to be inclusive in a manner similar to the term “comprising”.

Furthermore, the subject matter described above is provided by way of illustration only and should not be construed as limiting. Various modifications and changes may be made to the subject matter described herein without following the example embodiments and applications illustrated and described, and without departing from the broader spirit and scope of the present invention, which is set forth in the following claims.

That which is claimed is:

1. A method of managing delivery of a package to an intermediate delivery location by an initial carrier for subsequent delivery of the package to a user by a secondary carrier, the method comprising:
electronically processing receipt of the package, the package being received at the intermediate delivery location and delivered by the initial carrier;
accessing a data store utilizing a user identifier provided with the package to identify a user delivery address associated with the user identifier, wherein the data store comprises user information of a plurality of users and wherein the user information of each user is received during a registration process; and
electronically processing release of the package to the secondary carrier to deliver the package to the user delivery address, the secondary carrier being a different carrier to the initial carrier.

2. The method of claim 1, wherein the registration process comprises:
receiving, by electronic data communication over a network, user information including at least the user delivery address;
generating, using at least one processor, the user identifier wherein the user identifier is unique to each user;
storing in the data store the user delivery address in association with the user identifier;
determining, using at least one processor, the intermediate delivery location based at least in part on the proximity of the intermediate delivery location to the user delivery address; and
providing, by electronic data communication over a network, the user identifier and a physical address of the intermediate delivery location to which the package can be delivered by the initial carrier.

3. The method of claim 2, wherein the user identifier comprises a name of the user, the name of the user being included in the user information.

4. The method of claim 2, wherein the user identifier is generated using at least one processor and includes at least one of an alpha code, a numeric code, an alphanumeric code, a bar code, a two-dimensional bar code, a radio frequency identification tag, and combinations thereof.

5. The method of claim 2, wherein determining the intermediate delivery location comprises:
identifying a user zip code based at least in part on the user delivery address; and
determining, using at least one processor, the intermediate delivery location based at least in part on the proximity of the intermediate delivery location to the user zip code.

6. The method of claim 2, further comprising:
receiving, by electronic data communication over a network, notification preferences, wherein the notification preferences comprise at least a preferred media for receiving electronic notifications; and
storing in the data store the notification preferences in association with the user identifier.

7. The method of claim 6, wherein the electronic notifications comprise at least one of a notification when the package arrives at the intermediate delivery location, a notification when the package is released to the secondary carrier, and a notification when the secondary carrier at least attempts delivering the package to the user delivery address.

8. The method of claim 2, further comprising:
receiving, by electronic data communication over a network, delivery preferences, wherein the delivery preferences comprise at least one of a preferred time and a preferred day for receiving packages from the secondary carrier; and
storing in the data store the delivery preferences in association with the user identifier.

9. The method of claim 2, further comprising:
receiving, by electronic data communication over a network, payment information, wherein the payment information includes at least a payment method to electronically charge the user; and
storing in the data store the payment information in association with the user identifier.

10. The method of claim 2, wherein the user information is received from a computing device and wherein the computing device comprises at least one of a user client device, a client device at the intermediate delivery location, and an electronic commerce retailer server.

11. The method of claim 2, wherein the user information is received directly from at least one of the user, the intermediate delivery location, and an electronic commerce retailer.

12. The method of claim 1, wherein electronically processing receipt of the package comprises:
receiving from the intermediate delivery location, by electronic data communication over a network, the user identifier wherein the user identifier is provided with the package received at the intermediate delivery location;
retrieving from the data store the user delivery address associated with the user identifier; and
electronically providing to the secondary carrier the user delivery address associated with the user identifier.

13. The method of claim 12, further comprising:
receiving from the intermediate delivery location, by electronic data communication over a network, package information, wherein the package information comprises at least one of a tracking number and a sender name;
storing in the data store the package information in association with the user identifier; and
providing, by electronic data communication over a network, the package information to at least one of the user, the intermediate delivery location, and the secondary carrier.

14. The method of claim 12, further comprising:
accessing the data store to identify notification preferences associated with the user identifier; and
providing to the user an electronic notification indicating receipt of the package, wherein the notification is provided to the user based at least in part on the notification preferences associated with the user identifier.

15. The method of claim 12, further comprising:
accessing the data store to identify delivery preferences associated with the user identifier;
determining, using at least one processor, a projected delivery window, wherein the projected delivery window is determined based at least in part on the delivery preferences associated with the user identifier; and
providing, by electronic data communication over a network, the projected delivery window to at least one of the user, the intermediate delivery location, and the secondary carrier.

16. The method of claim 12, further comprising:
accessing the data store to identify payment information associated with the user identifier, wherein the payment information comprises at least a payment method to electronically charge the user; and
electronically charging the user in response to receiving the package at the intermediate delivery location based at least in part on the payment method associated with the user identifier.

17. The method of claim 12, wherein electronically providing to the secondary carrier the user delivery address comprises electronic data communication over a network.

18. The method of claim 1, wherein electronically processing release of the package to the secondary carrier comprises:
generating, using a computing device at the intermediate delivery location, a shipping label bearing the user delivery address;
affixing the shipping label to the package; and
releasing the package with the affixed label to the secondary carrier.

19. The method of claim 1, wherein electronically processing release of the package to the secondary carrier comprises:
accessing the data store to identify delivery preferences associated with the user identifier;
determining, using at least one processor, a projected delivery window, wherein the projected delivery window is determined based at least in part on the delivery preferences associated with the user identifier; and
releasing the package to the secondary carrier based at least in part on the projected delivery window of the package.

20. A system to manage delivery of a package to an intermediate delivery location by an initial carrier for subsequent delivery of the package to a user by a secondary carrier, the system comprising:
a receipt processing module configured to electronically process receipt of the package, the package being received at the intermediate delivery location and delivered by the initial carrier;
a data access module configured to access a data store to identify a user delivery address associated with a user identifier provided with the package, wherein the data store comprises user information of a plurality of users and wherein the user information of each user is received during a registration process; and
a release processing module configured to process release of the package to the secondary carrier to deliver the package to the user delivery address, the secondary carrier being a different carrier to the initial carrier.

21. The system of claim 20, wherein:
user information including at least the user delivery address is received by electronic data communication over a network;
the user identifier is generated using at least one processor and wherein the user identifier is unique to each user;
the user delivery address is stored in association with the user identifier in the data store;
the intermediate delivery location is determined, using at least one processor, based at least in part on proximity of the intermediate delivery location to the user delivery address; and
the user identifier and a physical address of the intermediate delivery location to which the package can be delivered by the initial carrier are provided to the user by electronic data communication over a network.

22. The system of claim 20, wherein:
the user identifier is received, by electronic data communication over a network, from the intermediate delivery location, and wherein the user identifier is provided with the package received at the intermediate delivery location;
the user delivery address associated with the user identifier is retrieved from the data store; and
the user delivery address associated with the user identifier is electronically provided to the secondary carrier.

23. A non-transitory computer-readable storage medium having computer-readable instructions stored thereon which, when executed by a computer, cause the computer to:
process receipt of the package, the package being received at the intermediate delivery location and delivered by the initial carrier;
access a data store to identify a user delivery address associated with a user identifier provided with the package, wherein the data store comprises user information of a plurality of users and wherein the user information of each user was previously provided in a registration process; and
process release of the package to the secondary carrier to deliver the package to the user delivery address, the secondary carrier being a different carrier to the initial carrier.

24. The computer-readable medium of claim 23, wherein the instructions cause the computer to:
receive, by electronic data communication over a network, user information including at least the user delivery address;
generate, using at least one processor, the user identifier wherein the user identifier is unique to each user;
store in the data store the user delivery address in association with the user identifier;
determine, using at least one processor, the intermediate delivery location based at least in part on the proximity of the intermediate delivery location to the user delivery address; and
provide, by electronic data communication over a network, the user identifier and a physical address of the intermediate delivery location to which the package can be delivered by the initial carrier.

25. The computer-readable medium of claim 23, wherein the instructions cause the computer to:
receive from the intermediate delivery location, by electronic data communication over a network, the user identifier wherein the user identifier is provided with the package received at the intermediate delivery location;
retrieve from the data store the user delivery address associated with the user identifier; and
provide to the secondary carrier the user delivery address associated with the user identifier.
